(19) United States
(12) Patent Application Publication
(10) Pub. No.: US 2017/0348998 A1
(43) Pub. Date: Dec. 7, 2017

(54) MECHANICAL-PENCIL CAP SERVING AS TOUCH-PEN TIP AND PENCIL-LEAD SHARPENER, AND MECHANICAL PENCIL HAVING THE SAME

(71) Applicant: DREAM OFFICE CO., LTD., Seoul (KR)

(72) Inventor: Hak Sang KIM, Seoul (KR)

(21) Appl. No.: 15/541,302

(22) PCT Filed: Jun. 19, 2015
(86) PCT No.: PCT/KR2015/006258

§ 371 Date: Jun. 30, 2017

(30) Foreign Application Priority Data
Dec. 31, 2014 (KR) 10-2014-0194658

(51) Int. Cl. B43K 23/08; B43K 29/06

(52) U.S. Cl. CPC B43K 23/08; B43K 29/06

(57) ABSTRACT

Provided are a mechanical-pencil cap serving as a touch-pen tip and a pencil-lead sharpener, and a mechanical pencil having the mechanical-pencil cap. The mechanical-pencil cap includes a front fixing part (11b) for the touch-pen tip formed in a shape of a truncated conical recess, and a pencil-lead sharpener functioning part (11c) provided to be opposite to the front fixing part (11b) for the touch-pen tip, and connected to the touch-pen tip (11f) formed to surround an outer circumference of a touch-pen tip fixing member (11e). This enables an input operation into a mobile terminal, such as a smartphone or a smart pad having a capacitive touch screen, to be performed in a touch manner, and allows a pencil lead inserted into a pencil-lead insert container and ejected out when in use to be conveniently sharpened without the necessity of separating the pencil lead.

### BACKGROUND

The present invention relates to a mechanical-pencil cap serving as a touch-pen tip and a pencil-lead sharpener, and a mechanical pencil having the mechanical-pencil cap. More particularly, the present invention relates to a mechanical-pencil cap serving as both a touch-pen tip and a pencil-lead sharpener, which enables an input operation into a mobile terminal, such as a smartphone or a smart pad having a capacitive touch screen, to be performed in a touch manner, and allows a pencil lead inserted into a pencil-lead insert container and ejected out when in use to be conveniently sharpened without the necessity of separating the pencil lead, and to a mechanical pencil having the mechanical-pencil cap.

Generally, a conventional mechanical pencil has been used with a lead having a thickness that is the same as that of a pencil lead.

However, such a lead should be sharpened unlike the typical lead of the mechanical pencil. To this end, a mechanical-pencil cap having a pencil-lead sharpener has been proposed.

Therefore, the present invention is intended to provide a pencil-lead sharpener differentiated from a conventional structure.

### CITED REFERENCES

1. SHARP PENCIL (Korean Patent Appl. No. 10-1985-0000731)

2. AUTOMATIC MECHANICAL PENCIL (Korean Patent Appl. No. 10-2000-0020749)

### SUMMARY OF THE INVENTION

The present invention has been made in an effort to solve the above-described problems associated with related art. An object of the present invention is to provide a mechanical-pencil cap serving as both a touch-pen tip and a pencil-lead sharpener, which enables an input operation into a mobile terminal, such as a smartphone or a smart pad having a capacitive touch screen, to be performed in a touch manner, and allows a pencil lead inserted into a pencil-lead insert container and ejected out when in use to be conveniently sharpened without the necessity of separating the pencil lead, and to provide a mechanical pencil having the mechanical-pencil cap.

Objects of the present invention are not limited to the above-mentioned objects, and other objects that are not mentioned herein will be clearly understood by those skilled in the art from the following description.

In order to accomplish the above object, the present invention provides a mechanical-pencil cap serving as a touch-pen tip and a pencil-lead sharpener including a front fixing part 11b for the touch-pen tip formed in a shape of a truncated conical recess; and a pencil-lead sharpener functioning part 11c provided to be opposite to the front fixing part 11b for the touch-pen tip, and connected to the touch-pen tip 11f formed to surround an outer circumference of a touch-pen tip fixing member 11e.

The mechanical-pencil cap may further include a body inserting/fixing part 11a formed on a rear end of the mechanical-pencil cap 11 in the shape of an annular edge, and having two upper and lower protrusions to engage with two fastening grooves that are formed on upper and lower regions of a pencil-lead ejecting and cap fixing part 15 of a mechanical pencil with the mechanical-pencil cap serving as the touch-pen tip and the pencil-lead sharpener.

Further, the front fixing part 11b for the touch-pen tip may be formed to surround and fix a portion located in front of the fastening grooves of the pencil-lead ejecting and cap fixing part 15 when the pencil-lead ejecting and cap fixing part 15 is inserted.

Further, the touch-pen tip fixing member 11e may be made of an elastic material in a shape of a dome (hemisphere), and a pencil-lead insert hole 11g may be formed in a center of the touch-pen tip fixing member.

Further, a blade 11e may be formed in a central portion of a front region of the pencil-lead sharpener functioning part 11c to sharpen the pencil lead 16 inserted through the pencil-lead insert hole 11g.

In order to accomplish the above object, the present invention provides a mechanical pencil with a mechanical-pencil cap serving as a touch-pen tip and a pencil-lead sharpener, wherein, if the mechanical-pencil cap 11 serving as the touch-pen tip and the pencil-lead sharpener is separated from a rear end of the mechanical pencil, is moved to a front of mechanical pencil and a mounting surface of the mechanical-pencil cap 11 when it is mounted on the rear end of the mechanical pencil is fastened to a front end of the mechanical pencil, the mechanical-pencil cap is used as the touch-pen tip, and, if the mechanical-pencil cap 11 is separated from the rear end and a surface opposite to the mounting surface of the mechanical-pencil cap 11 when it is used as the touch-pen tip is fastened to the mechanical pencil, the pencil lead 16 of the mechanical pencil is inserted into the pencil-lead insert hole 11g defined in the mechanical-pencil cap 11 to be surrounded by the touch-pen tip 11f, so that the mechanical-pencil cap serves as the pencil-lead sharpener by the blade 11d in the mechanical-pencil cap 11 when either of the mechanical-pencil cap 11 or the mechanical pencil is rotated by an external force.

The mechanical-pencil cap serving as both a touch-pen tip and a pencil-lead sharpener, and the mechanical pencil having the mechanical-pencil cap according to an embodiment of the present invention enable the input operation into the mobile terminal, such as the smartphone or the smart pad having the capacitive touch screen, to be performed in a touch manner, and allow the pencil lead inserted into the pencil-lead insert container and ejected out when in use to be conveniently sharpened without the necessity of separating the pencil lead.

### BRIEF DESCRIPTION OF THE DRAWINGS

FIG. 1 is a view illustrating an entire mechanical pencil with a mechanical-pencil cap serving as a touch-pen tip and a pencil-lead sharpener according to an embodiment of the present invention;

FIG. 2 is a sectional view illustrating the mechanical pencil with the mechanical-pencil cap serving as the touch-pen tip and the pencil-lead sharpener of FIG. 1;

FIG. 3 is a detailed view illustrating the configuration of the mechanical-pencil cap 11 serving as the touch-pen tip and the pencil-lead sharpener of FIG. 1;

FIG. 4 is a view illustrating a state in which the mechanical-pencil cap 11 closing a pencil-lead insert container 13 and fastened to a mechanical-pencil body 14 is separated from a rear end of the mechanical pencil with the mechanical-pencil cap serving as the touch-pen tip and the pencil-lead sharpener of FIG. 1, and then is fastened to a pencil-lead ejecting and cap fixing part 15 provided on a front end of the mechanical pencil;

FIG. 5 is an enlarged view illustrating the structure of the mechanical-pencil cap 11 when it is fastened to the pencil-lead ejecting and cap fixing part 15 provided on the front end of the mechanical pencil of FIG. 4;

FIG. 6 is a view illustrating a state in which a pencil lead 16 of the mechanical pencil is inserted through a pencil-lead insert hole 11g formed in a central portion of the touch-pen tip 11f and comes into contact with a blade 11d, at the front end of the mechanical pencil with the mechanical-pencil cap serving as the touch-pen tip and the pencil-lead sharpener of FIG. 1;

FIG. 7 is an enlarged view illustrating the structure of the mechanical-pencil cap 11 used as the pencil-lead sharpener, in a state in which the pencil lead 16 of the mechanical pencil of FIG. 6 is inserted to come into contact with the blade 11d;

FIG. 8 is a view illustrating the use of the touch tip and a one-sided pencil-lead sharpener described in FIGS. 1 to 7;

FIGS. 9a and 9b are views illustrating a structure having only a touch tip and causing a pencil lead to be ejected according to another embodiment of the present invention; and FIG. 9b is a view illustrating the use of the touch tip and a one-sided pencil-lead sharpener described in FIG. 9a;

FIGS. 10a and 10b are views illustrating the use of a touch tip and a double-sided pencil-lead sharpener according to a further embodiment of the present invention and 10b is a view illustrating the use of the touch tip and a one-sided pencil-lead sharpener described in FIGS. 10a.

### DETAILED DESCRIPTION OF THE INVENTION

Exemplary embodiments of the present invention will be described below in detail with reference to the accompanying drawings. Further, in the description of this invention, the description of known functions or configurations will be omitted herein to make the gist of this invention clear.

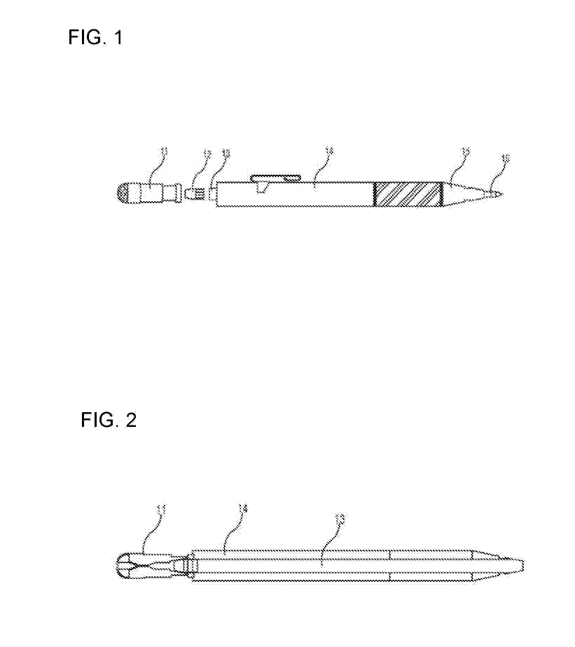

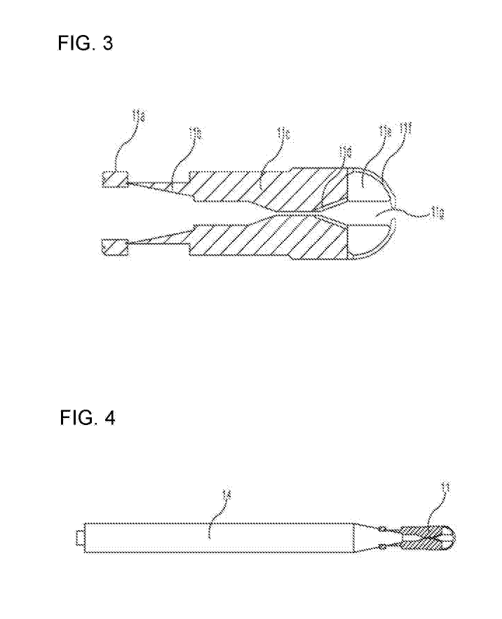

FIG. 1 is a view illustrating an entire mechanical pencil with a mechanical-pencil cap serving as a touch-pen tip and a pencil-lead sharpener according to an embodiment of the present invention. FIG. 2 is a sectional view illustrating the mechanical pencil with the mechanical-pencil cap serving as the touch-pen tip and the pencil-lead sharpener of FIG. 1. FIG. 3 is a detailed view illustrating the configuration of the mechanical-pencil cap 11 serving as the touch-pen tip and the pencil-lead sharpener of FIG. 1.

First, referring to FIG. 1, the mechanical pencil with the mechanical-pencil cap serving as the touch-pen tip and the pencil-lead sharpener includes a mechanical-pencil cap 11 serving as both the touch-pen tip and the pencil-lead sharpener, an eraser part 12, a pencil-lead insert container 13, a mechanical-pencil body 14, a pencil-lead ejecting and cap fixing part 15, and a pencil lead 16.

In this regard, as illustrated in FIG. 1, the mechanical-pencil cap 11 serving as the touch-pen tip and the pencil-lead sharpener is usually mounted on a rear end of the mechanical pencil. However, after the mechanical-pencil cap 11 serving as the touch-pen tip and the pencil-lead sharpener is separated from the rear end of the mechanical pencil and is moved to a front of mechanical pencil, a mounting surface of the mechanical-pencil cap 11 when it is mounted on the rear end of the mechanical pencil may be fastened to a front end of the mechanical pencil. In this case, the mechanical-pencil cap may be used as the touch-pen tip (see, FIG. 4). Meanwhile, if the mechanical-pencil cap 11 of FIG. 1 is separated from the rear end and a surface opposite to the mounting surface of the mechanical-pencil cap 11 when it is used as the touch-pen tip is fastened to the mechanical pencil, the pencil lead 16 of the mechanical pencil is inserted into the pencil-lead insert hole 11g defined in the mechanical-pencil cap 11 to be surrounded by the touch-pen tip 11f, so that the mechanical-pencil cap may serve as the pencil-lead sharpener by the blade 11d in the mechanical-pencil cap 11 when either of the mechanical-pencil cap 11 or the mechanical pencil is rotated by an external force (see, FIG. 6).

Next, referring to FIG. 3, the mechanical-pencil cap 11 serving as the touch-pen tip and the pencil-lead sharpener includes a body inserting/fixing part 11a, a front fixing part 11b for the touch-pen tip, a pencil-lead sharpener functioning part 11c, a blade 11d, a touch-pen tip fixing member 11e, a touch-pen tip 11f, and a pencil-lead insert hole 11g.

The body inserting/fixing part 11a is formed on a rear end of the mechanical-pencil cap 11 in the shape of an annular edge, and has two upper and lower protrusions to engage with two fastening grooves that are formed on upper and lower regions of the pencil-lead ejecting and cap fixing part 15.

The front fixing part 11b for the touch-pen tip is formed in front of the body inserting/fixing part 11a in the shape of a truncated conical recess, to surround and fix a portion located in front of the fastening grooves of the pencil-lead ejecting and cap fixing part 15 when the pencil-lead ejecting and cap fixing part 15 is inserted.

The pencil-lead sharpener functioning part 11c is connected at a rear end thereof to the front fixing part 11b for the touch-pen tip, and connected at a front end thereof to the touch-pen tip 11f that is formed to surround an outer circumference of the touch-pen tip fixing member 11e. Here, the touch-pen tip fixing member 11e is preferably made of an elastic material such as rubber or silicone, but is not limited thereto. The touch-pen tip fixing member is in the shape of a dome (hemisphere). The pencil-lead insert hole 11g having a diameter that is equal to or 0.1 to 0.2 mm larger than that of the pencil lead 16 is formed in a center of the touch-pen tip fixing member.

Further, two upper and lower blades are formed in a central portion of a front region of the pencil-lead sharpener functioning part 11c to sharpen the pencil lead 16 that is inserted through the pencil-lead insert hole 11g.

The touch-pen tip 11f is detachably attached to the touch-pen tip fixing member 11e, and is formed by coating a material such as flexible rubber or silicone with metal components to allow a capacitive touch. Thus, static electricity of a human body is transmitted through the mechanical-pencil cap 11 to a handle provided on a front portion of the mechanical-pencil body 14 that is entirely formed of or coated with a metal material, so that it is possible to input a signal to a mobile device such as a smartphone or a smart pad having a capacitive touch screen in a touch manner.

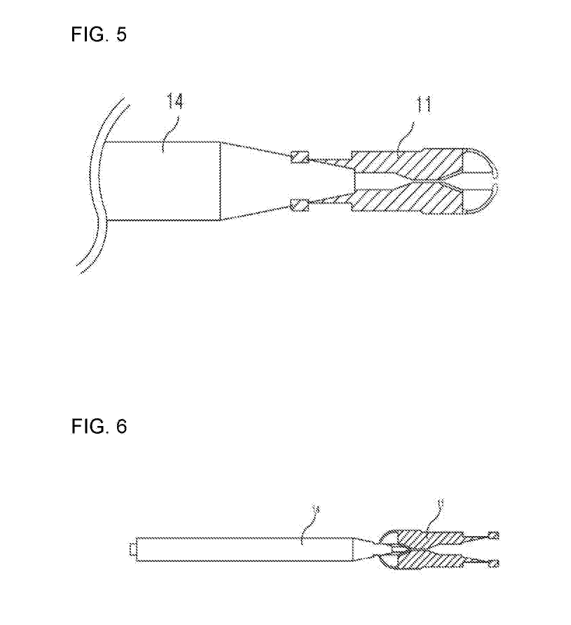

FIG. 4 is a view illustrating a state in which the mechanical-pencil cap 11 closing the pencil-lead insert container 13 and fastened to the mechanical-pencil body 14 is separated from the rear end of the mechanical pencil with the mechanical-pencil cap serving as the touch-pen tip and the pencil-lead sharpener of FIG. 1, and then is fastened to the pencil-lead ejecting and cap fixing part 15 provided on the front end of the mechanical pencil. Further, FIG. 5 is an enlarged view illustrating the structure of the mechanical-pencil cap 11 when it is fastened to the pencil-lead ejecting and cap fixing part 15 provided on the front end of the mechanical pencil of FIG. 4. That is, the front fixing part 11b for the touch-pen tip is formed to surround the outer circumference of the front fixing part 11b for the touch-pen tip, and the outer circumference of the pencil lead 16 of the mechanical pencil is surrounded by a region having the blade 11d formed in the pencil-lead sharpener functioning part 11c.

Meanwhile, a rear end of the blade 11d is open in the pencil-lead sharpener functioning part 11c, and is connected via a passage to a front end of the opposite region surrounding the outer circumference of the pencil lead 16 of the mechanical pencil in the pencil-lead sharpener functioning part 11c.

Such a passage connecting structure allows shavings produced when the pencil lead 16 is sharpened by the blade 11d of the pencil-lead sharpener functioning part 11c to be discharged to an outside.

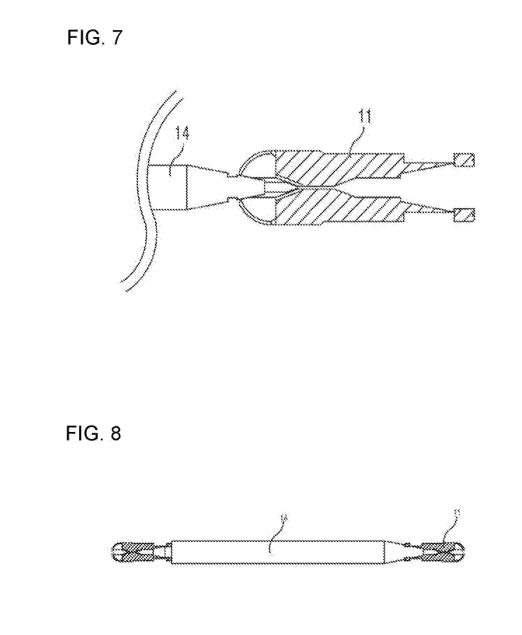

FIG. 6 is a view illustrating a state in which the pencil lead 16 of the mechanical pencil is inserted through the pencil-lead insert hole 11g formed in the central portion of the touch-pen tip 11f and comes into contact with the blade 11d, at the front end of the mechanical pencil with the mechanical-pencil cap serving as the touch-pen tip and the pencil-lead sharpener of FIG. 1. Further, FIG. 7 is an enlarged view illustrating the structure of the mechanical-pencil cap 11 used as the pencil-lead sharpener, in a state in which the pencil lead 16 of the mechanical pencil of FIG. 6 is inserted to come into contact with the blade 11d.

Meanwhile, FIG. 8 is a view illustrating the use of the touch tip and a one-sided pencil-lead sharpener described in FIGS. 1 to 7.

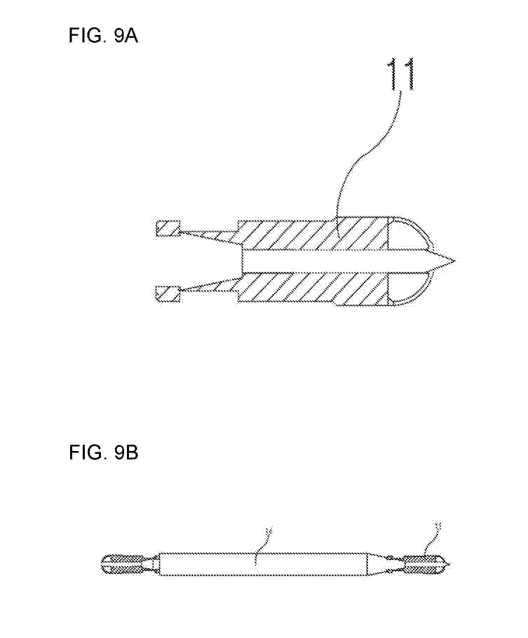

FIG. 9a is a view illustrating a structure having only a touch tip and causing a pencil lead to be ejected according to another embodiment of the present invention.

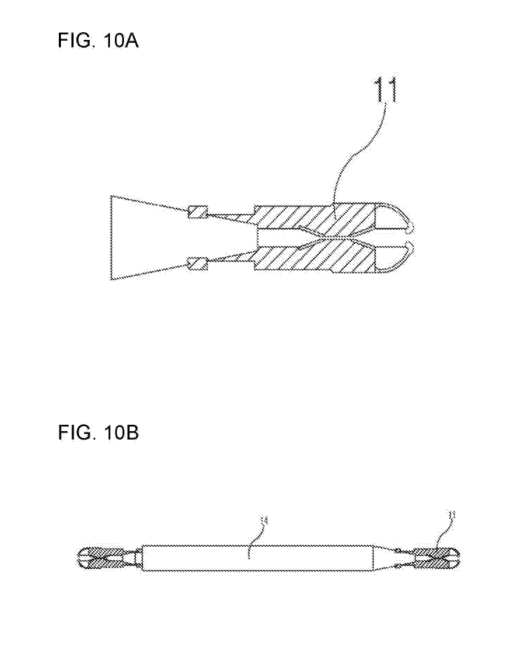

Further, FIG. 10a is a view illustrating the use of a touch tip and a double-sided pencil-lead sharpener according to a further embodiment of the present invention.

While the invention has been shown and described with reference to exemplary embodiments thereof, it will be understood by those skilled in the art that various changes in form and details may be made therein without departing from the spirit and scope of the invention as defined by the appended claims. Therefore, it is to be understood that the scope of the invention is not limited to the above-described embodiments, and all changes that fall within meets and bounds of the claims, or equivalence of such meets and bounds are intended to be embraced by the claims.

### DESCRIPTION OF REFERENCE NUMERALS

11: mechanical-pencil cap

11a: body inserting/fixing part

11b: front fixing part for touch-pen tip

11c: pencil-lead sharpener functioning part

11d: blade

11e: touch-pen tip fixing member

11f: touch-pen tip

11g: pencil-lead insert hole

12: eraser part

13: pencil-lead insert container

14: mechanical-pencil body

15: pencil-lead ejecting and cap fixing part

16: pencil lead

1. A mechanical-pencil cap serving as a touch-pen tip and a pencil-lead sharpener comprising:
a front fixing part (11b) for the touch-pen tip formed in a shape of a truncated conical recess; and
a pencil-lead sharpener functioning part (11c) provided to be opposite to the front fixing part (11b) for the touch-pen tip, and connected to the touch-pen tip (11f) formed to surround an outer circumference of a touch-pen tip fixing member (11e).

2. The mechanical-pencil cap of claim 1, further comprising:
a body inserting/fixing part (11a) formed on a rear end of the mechanical-pencil cap (11) in the shape of an annular edge, and having two upper and lower protrusions to engage with two fastening grooves that are formed on upper and lower regions of a pencil-lead ejecting and cap fixing part (15) of a mechanical pencil with the mechanical-pencil cap serving as the touch-pen tip and the pencil-lead sharpener.

3. The mechanical-pencil cap of claim 1, wherein the front fixing part (11b) for the touch-pen tip is formed to surround and fix a portion located in front of the fastening grooves of the pencil-lead ejecting and cap fixing part (15) when the pencil-lead ejecting and cap fixing part (15) is inserted.

4. The mechanical-pencil cap of claim 1, wherein the touch-pen tip fixing member (11e) is made of an elastic material in a shape of a dome (hemisphere), and a pencil-lead insert hole (11g) having a diameter that is equal to or 0.1 to 0.2 mm larger than that of a pencil lead (16) is formed in a center of the touch-pen tip fixing member.

5. The mechanical-pencil cap of claim 1, wherein a blade (11d) is formed in a central portion of a front region of the pencil-lead sharpener functioning part (11c) to sharpen the pencil lead (16) inserted through the pencil-lead insert hole (11g).

6. A mechanical pencil with a mechanical-pencil cap serving as a touch-pen tip and a pencil-lead sharpener,
wherein, if the mechanical-pencil cap (11) serving as the touch-pen tip and the pencil-lead sharpener is separated from a rear end of the mechanical pencil, is moved to a front of mechanical pencil and a mounting surface of the mechanical-pencil cap (11) when it is mounted on the rear end of the mechanical pencil is fastened to a front end of the mechanical pencil, the mechanical-pencil cap is used as the touch-pen tip, and, if the mechanical-pencil cap (11) is separated from the rear end and a surface opposite to the mounting surface of the mechanical-pencil cap (11) when it is used as the touch-pen tip is fastened to the mechanical pencil, the pencil lead (16) of the mechanical pencil is inserted into the pencil-lead insert hole (11g) defined in the mechanical-pencil cap (11) to be surrounded by the touch-pen tip (11f), so that the mechanical-pencil cap serves as the pencil-lead sharpener by the blade (11d) in the mechanical-pencil cap (11) when either of the mechanical-pencil cap (11) or the mechanical pencil is rotated by an external force.
